(19) United States
(12) Patent Application Publication
(10) Pub. No.: US 2021/0245132 A1
(43) Pub. Date: Aug. 12, 2021

(54) FUNCTIONAL MULTI-WALLED CORE-SHELL PARTICLES

(71) Applicant: RUDOLF GMBH, Geretsried (DE)

(72) Inventors: Jonas NAWROTH, Wolfratshausen (DE); Dirk SIELEMANN, Wolfratshausen (DE); Gunther DUSCHEK, Benediktbeuern (DE)

(73) Assignee: RUDOLF GMBH, Geretsried (DE)

(21) Appl. No.: 16/972,914

(22) PCT Filed: Jun. 24, 2019
(86) PCT No.: PCT/EP2019/066620

§ 371 Date: Dec. 7, 2020

(30) Foreign Application Priority Data
Jun. 25, 2018 (EP) 18179544.4

(51) Int. Cl. B01J 13/22; B01J 13/18; C08G 18/80; C08G 18/75; C08G 18/32; D06C 7/00; D06M 23/08

(52) U.S. Cl. CPC B01J 13/22; B01J 13/18; C08G 18/808; D06M 23/08; C08G 18/3225; D06C 7/00; C08G 18/755

(57) ABSTRACT

The present invention relates to core-shell particles comprising a core comprising at least one lipophilic compound and a shell comprising at least one layer close to the core and one layer far from the core. The invention further relates to the preparation of such core-shell particles and their use, particularly in the finishing of fibers and textiles.

The present invention relates to core-shell particles comprising a core comprising at least one lipophilic compound and a shell comprising at least one layer close to the core and one layer far from the core. The invention further relates to the preparation of such core-shell particles and their use, particularly in the finishing of fibers and textiles.

The microencapsulation of lipophilic compounds is known: Thereby, the mostly liquid or solid compounds are covered by a cover in smallest portions and thus immobilized. The binding of the cover is usually caused by coacervation, interface reactions or in situ polymerization techniques. For this purpose, the compound to be encapsulated is usually dispersed in a liquid medium and the cover is formed at the interface between compound and medium. Particular attention was previously paid to melamine formaldehyde microcapsules. As described above, first a dispersion of medium and compound to be encapsulated is made, to which a melamine formaldehyde prepolymer is added. The prepolymer cures at the interface and forms a solid impermeable cover with mechanically acceptable properties. Since, as is known, formaldehyde can be released from the condensates, melamine formaldehyde microcapsules become less and less important for health reasons.

EP 1 246 693 suggests the addition of melamine during the curing phase of the melamine formaldehyde resin shell to reduce the subsequent release of formaldehyde.

From DE 2 242 910, it is known that a cover of polyurea can be prepared by an interface reaction of polyisocyanates with polyamines.

EP 1 029 018 describes the formation of capsule walls by polymerization of acrylates. Experiments were conducted to additionally functionalize the cover.

On the basis of the systems described above, a functionalization is either not possible or negatively influences the morphology of the cover, e.g. by the formation of pores, channels, etc.

For instance, it is known from WO 2012/075293 that during the polymerization of the polar monomer N,N-dimethyl aminoethyl methacrylate hydrogel structures are formed. Thus, during swelling, channels and pores are formed that facilitate the outward diffusion of the active substance of the core.

U.S. Pat. No. 8,747,999 describes a core-shell particle, the shell of which is prepared by a simultaneous reaction of a melamine formaldehyde resin with a diallyl dimethyl ammonium chloride copolymer. The shell thus carries functional groups in the form of cationic units and reactive methylol functions. The shell can, however, not be functionalized arbitrarily high, since this inevitably leads to a disturbance of the shell structure.

EP 2 043 773 discloses the subsequent functionalization of a core-shell particle by coating with a polyelectrolyte.

Further, the prior art described microencapsulations, wherein more than two covers are formed around the core.

WO 2013/182855 discloses a core-shell particle with two stacked polyurea covers as shell. By the double encapsulation, permeability can be reduced.

The application of the second polyurea cover onto the first polyurea cover is, however, complicated and requires further chemicals.

U.S. Pat. No. 8,329,233 describes core-shell particles having a melamine formaldehyde cover, which is in turn coated by a polyacrylate cover. The outer polyacrylate cover is supposed to prevent the release of formaldehyde. The potential risk of formaldehyde release can, however, not be excluded.

EP 1 513 610 discloses a core-shell particle with double-wall structure with the aim of decreasing permeability. The covers made of polyurethane and polyurea are crosslinked to each other, which may cause the formation of blemishes in the respective covers.

U.S. Pat. No. 7,025,912 describes a core-shell particle with double-wall structure, the inner cover of which consists of polyurea and the outer cover of which is constructed on the basis of ethylenically unsaturated monomers. Ethylenically unsaturated surfactants that serve as anchor point for the second cover are embedded in the polyurea cover. The use of the surfactants may cause disturbances, e.g. pores or channels, in the polyurea cover. Further, the inner polyurea cover is not sufficiently compatible with the core material.

In view of the prior art, the subject of the present invention was to encapsulate a lipophilic compound. The shell of the capsule should on the one hand be inert to the lipophilic compound. Further, the properties of the shell, e.g. permeability, mechanical strength, functionality, etc., should be adjustable in a variable and reproducible way. In the following, functionality particularly means the modification of the shell with functional, particularly functional chemical, groups. It was surprisingly shown that the problem is solved by the core-shell particle according to the invention, which comprises (a) a core comprising at least one lipophilic compound and (b) a shell comprising at least one layer close to the core and one layer far from the core.

The aggregate phase of the core may be gaseous, solid or liquid, preferably, the core is solid at room temperature (20° C.) and can for example be present in the form of a powder. In another preferred embodiment, the core is liquid at room temperature (20° C.) and can also be present in the form of a solution, emulsion or suspension at this temperature. In a preferred embodiment, the core comprises at least 80 wt.-%, more preferably at least 90 to 99 wt.-% of the at least one lipophilic compound (based on the total mass of the core). In a preferred embodiment, the core consists of at least one lipophilic compound.

In a preferred embodiment, the lipophilic compound has a water solubility of <10 g/l, more preferably <5 g/l, even more preferably <3 g/l at 20° C.

Preferred lipophilic compounds, which can optionally be slurried in a carrier oil, are selected from pigments, dyes, fragrances, cosmetics, flame retardants, latent heat storage materials, biocides, catalysts, adhesives, adhesive components, hydrophobing agents, polymer building blocks, isocyanates, oils, silicone oils, waxes or mixtures thereof. Suitable carrier oils are for example mono-, di- or triglyceride, mineral oil, silicone oil, castor oil and isopropyl myristate or mixtures thereof. Latent heat storage materials describe substances having a phase transition. The phase transition should take place in the range of the respective application temperature, the used latent heat storage material preferably is a substance having a solid/liquid phase transition in the temperature range of −20 to 120° C. Latent heat storage materials for clothing materials typically have a phase transition between 15 and 35° C.

Suitable latent heat storage materials are preferably selected from
saturated or unsaturated, linear, branched or cyclic hydrocarbon, preferably saturated or unsaturated, linear, branched or cyclic C₁₀-C₄₀-hydrocarbon, more preferably linear or cyclic C₁₀-C₄₀-alkane and aromatic C₆-C₂₀ hydrocarbon, most preferably n-hexadecane, n-heptadecane, n-octadecane, n-nonadecane, n-eicosane, cyclohexane, cyclooctane, cyclodecane, benzene, naphthalene, biphenyl,
saturated or unsaturated C₆-C₃₀-fatty acid, saturated or unsaturated C₆-C₃₀-fatty alcohol and saturated or unsaturated C₆-C₃₀-fatty acid-C₁-C₁₀-alkyl ester, preferably lauric, stearic, oleic or behenic acid, lauryl, stearyl or oleyl alcohol, propyl palmitate, methyl stearate or methyl palmitate, and
mixtures thereof.

Dyes can be selected from reactive dye, such as e.g. C.I. Reactive Red 2, disperse dye, such as e.g. C.I. Disperse Yellow 42, acid dye, such as e.g. C.I. Acid Blue 1, or basic dye, such as e.g. C.I. Basic Violet 3 and mixtures thereof.

Pigments are color-giving substances that are virtually insoluble in the application medium, e.g. oils. Preferred pigments are either inorganic or organic pigments. Pigments can also be classified by their optical properties (specific color) and by their technical properties (corrosion protection, magnetism). In the latter case, color pigments, magnetic pigments and mixtures thereof are preferred.

Fragrances according to the present invention may be of synthetic or natural nature. Natural fragrances e.g. comprise oily flower and/or fruit rind extracts or essential oils. Synthetic fragrances for example comprise ester, ether or aldehyde.

The used flame retardants preferably are halogenated flame retardants, more preferably tetrabromobisphenol A (TBA), bromopolystyrene, chlorinated paraffins and dibromoneopentylglycol (DBNPG), phosphoric flame retardants, more preferably organic phosphoric acid ester or cyclic phosphate derivatives, or mixtures thereof.

Biocides according to the present invention are preferably selected from pesticides, fungicides, herbicides, insecticides, algicides, molluscicides, acaricides, rodenticides, bactericides, antibiotics, antiseptics, antibacterial, antiviral, antifungal, antiparasitic biocides and mixtures thereof.

Cosmetics are preferably selected from anti-wrinkle agents, radical quenchers, self-tanning agents and/or massage oils.

Among others, N,N′-dimethylaminoethanol, N,N′-dimethyl cyclohexylamine, tin(II)-2-ethylhexanoate, dibutyltin dilaurate and mixtures thereof may be used as catalysts.

Adhesives and adhesive components for example comprise one-component and two-component systems, e.g. on the basis of lipophilic isocyanates, polyols, polyamines, carbodiimides, organotin compounds, acrylates and/or epoxides.

Suitable oils preferably comprise natural or synthetic oils. Preferred are aliphates, such as saturated, unsaturated and/or cyclic hydrocarbons, aromatic hydrocarbons, such as e.g. benzene, xylene, naphthalene and/or toluene, vegetable oils, such as e.g. soybean oil, olive oil and/or rapeseed oil, silicone oil, as well as mixtures thereof.

Suitable waxes for example comprise polyolefin waxes such as e.g. polyethylene wax, carnauba wax, polyvinyl ether wax, and mixtures thereof.

In a preferred embodiment, the shell comprises a layer close to the core and a layer far from the core. In a preferred embodiment, the shell essentially consists of a layer close to the core and a layer far from the core. In a preferred embodiment, the shell consists of a layer close to the core and a layer far from the core and optionally expedients.

In a preferred embodiment, each the layer far from the core and/or the layer close to the core, particularly the layer far from the core and the layer close to the core, is covalently crosslinked.

In a preferred embodiment, the layer close to the core directly surrounds the core.

In a preferred embodiment, the layer far from the core is disposed on the layer close to the core, i.e. particularly no additional covalently crosslinked layer is disposed between the layer far from the core and the layer close to the core.

In a preferred embodiment, the—optionally covalently crosslinked—layer close to the core and the—optionally covalently crosslinked—layer far from the core are not covalently linked to each other.

The layer far from the core and/or the layer close to the core are/is preferably a polymer, particularly a crosslinked polymer, for example on the basis of a polyolefin, polyacrylate, polyurethane, which can optionally also contain one or more allophanate, carbodiimide, isocyanurate, biuret, uretdion, urea, iminooxadiazinedione and/or uretonimine groups, polyallophanate, polycarbodiimide, polyisocyanurate, polybiuret, polyuretdion, polyurea, polyiminooxadiazinedione, polyuretonimine, epoxy resin, vinyl polymer, allyl polymer, particularly on the basis of a polyacrylate or a polyurethane.

Preferably, the layer close to the core is on the basis of a polymer of at least one ethylenically unsaturated monomer, particularly of a crosslinked polyacrylate polymer. The layer far from the core is preferably on the basis of a polyurethane, which can optionally also contain one or more allophanate, carbodiimide, isocyanurate, biuret, uretdion, urea, iminooxadiazinedione and/or uretonimine groups, polyallophanate, polycarbodiimide, polyisocyanurate, polybiuret, polyuretdion, polyurea, polyiminooxadiazinedione and/or polyuretonimine, particularly on the basis of a crosslinked polyurethane and polyurea.

The layer close to the core is preferably inert to the core. It is further preferred that the layer close to the core does not contain functional groups, particularly no functional groups that enable a covalent linkage with the layer far from the core.

In a preferred embodiment, the layer close to the core is obtainable by polymerization of at least one monomer with at least one ethylenically unsaturated group. Particularly preferred, the layer close to the core is obtainable by polymerization of at least one monomer with a monoethylenically unsaturated group and at least one monomer with a polyethylenically unsaturated group.

Preferred ethylenically unsaturated groups are vinyl, vinyl ether, acryl, C₁-C₆-alkyl acryl, allyl and/or allyl ether groups.

Suitable monomers with at least one ethylenically unsaturated group preferably do not contain a nucleophilic group with an active hydrogen atom, particularly no nucleophilic group with an NCO-reactive hydrogen atom.

The monomer with at least one ethylenically unsaturated group is preferably selected from compounds with the following structures:

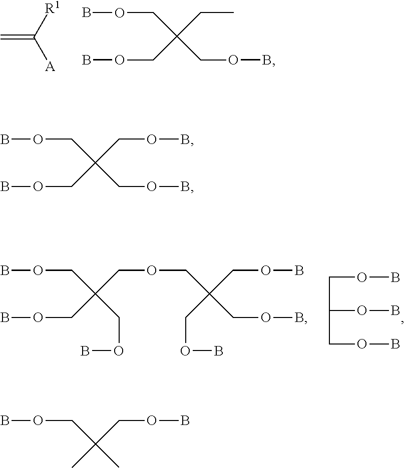

with

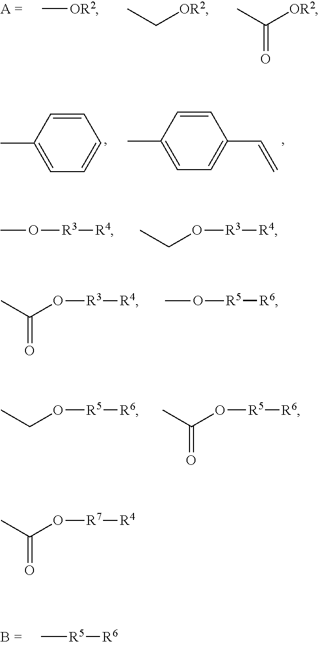

R¹=—C₁-C₆-alkyl or —H, preferably —H or —CH₃,
R²=linear or branched C₁-C₂₄-alkyl,
R³=linear or branched C₁-C₂₄-alkylene,

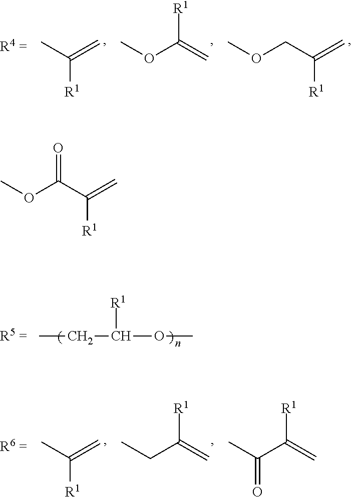

R⁷=polyester, particularly obtainable by reaction of C₁-C₆-alkyldiols and C₁-C₆-alkyldicarboxyilic acids, such as e.g. malonic acid, oxalic acid, succinic acid, glutaric acid or adipic acid, and
n=0-20.

Preferred monomers with one ethylenically unsaturated group are C₁-C₂₄-alkyl ester of the (meth)acrylic acid, C₁-C₂₄-vinyl ether, C₁-C₂₄-allyl ether and styrene. “Alkyl” in the sense of the present invention is a saturated, linear, cyclic or branched hydrocarbon. Particularly preferred, monomers with one ethylenically unsaturated group are methyl, ethyl, n-propyl, n-butyl, iso-butyl (sec-butyl and tert-butyl) and iso-propyl (meth)acrylate.

As monomers with several, preferably 2, 3, 4 or 5, ethylenically unsaturated groups, diesters of diols and (meth)acrylic acid and diallyl and divinyl ethers of these diols are preferably used. Particularly preferred, monomers with several ethylenically unsaturated groups are selected from ethanediol diacrylate, ethylene glycol dimethacrylate, 1,3-butyleneglycolmethacrylate, allyl acrylate, allyl methacrylate, polyester of polyols and (meth)acrylic acid and polyallyl and polyvinyl ethers of these polyols, particularly butandioldi(meth)acrylate, hexandioldi(meth)acrylate, trimethylolpropanetri(meth)acrylate and pentaeritrittetra(meth)acrylate.

Preferably, the layer close to the core is obtained by radical polymerization. Suitable radical polymerization initiators are besides UV initiators and redox initiators particularly peroxides, hydroperoxides, azo compounds, persulfates, perborates or mixtures thereof.

The layer close to the core is preferably obtained by radical polymerization of methyl(meth)acrylate, ethyl(meth)acrylate, N-propyl(meth)acrylate or N-butyl(meth)acrylate and butanedioldi(meth)acrylate and/or trimethylolpropantri(meth)acrylate.

The molar ratio of monomers with one ethylenically unsaturated group to monomers with several ethylenically unsaturated groups preferably is 0 to 40, more preferably 2 to 40, even more preferably 4 to 30.

In another embodiment, the layer close to the core is obtainable by polymerization of 100 mol-% of monomers with one ethylenically unsaturated group.

The polymer of the layer close to the core preferably contains at least 55 mol-%, more preferably at least 60 mol-%, even more preferably at least 65 mol-% and most preferably at least 70 mol-% of monomers with one ethylenically unsaturated group based on the total amount of substance of the monomers in the layer close to the core, for example 70 to 100 mol-%.

The amount of monomers with several ethylenically unsaturated groups in the layer close to the core for example amounts to 0 to 45 mol-%, preferably up to 30 mol-%, such as 5 to 30 mol-%, more preferably up to 20 mol-%, for example 10 to 20 mol-%, even more preferably up to 15 mol-%, for example 10 to 15 mol-% and most preferably 0.01 to 30 mol-% based on the total amount of substance of the monomers in the layer close to the core.

In a preferred embodiment, the layer close to the core is obtainable by polymerization of at least 80 mol-% of monomers with one ethylenically unsaturated group and up to 20 mol-% of monomers with several ethylenically unsaturated groups.

The ratio of monomers with one ethylenically unsaturated group and monomers with several ethylenically unsaturated groups determines the crosslinking level. The crosslinking level significantly influences e.g. the mechanical stability and the permeability of the layer. For instance, mechanical stability usually increases with an increasing crosslinking level (i.e. with an increasing amount of monomers with several ethylenically unsaturated groups), at the same time permeability decreases. The thickness of the layer close to the core is also important for mechanical stability and permeability. The thicker the layer, the lower permeability usually is and the higher mechanical stability usually is.

The layer far from the core preferably contains at least one urethane, allophanate, carbodiimide, isocyanurate, biuret, uretdione, urea, iminooxadiazinedione and/or uretonimine group, more preferably at least one urethane and/or urea group.

In a preferred embodiment, the layer far from the core is an addition product of at least one polyisocyanate and at least one compound comprising at least two groups with NCO-reactive hydrogen atom, preferably hydroxy, amino, carboxylic acid, urethane and/or urea groups.

In a preferred embodiment, the layer far from the core is a polyurethane.

The polyisocyanate preferably is aromatic, alicyclic or aliphatic. Preferably, the polyisocyanate is selected from methylene diphenyl isocyanate (MDI), polymeric MDI, toluylene diisocyanate (TDI), triphenylmethane-4,4′,4″-triisocyanate, 2,4,6-triisocyanatetoluene, isophorone diisocyanate (IPDI), 4,4′-methylenebis-(cyclohexyl isocyanate) (H12MDI), methyl-2,4-cyclohexane-diisocyanate, 1,3,5-triisocyanatecyclohexane, 1,3,5-trimethylisocyanate-cyclohexane, trimethylene diisocyanate, 1,4,8-triisocyanateoctane, 1,3,6-triisocyanatehexane, hexamethylene diisocyanate, xylene diisocyanate (XDI), particularly 1,3- or 1,4-xylene diisocyanate and derivatives thereof, such as e.g. biuret-containing and isocyanurate-containing polyisocyanates.

A portion of the NCO groups of the polyisocyanate may be blocked. In blocked isocyanates, the NCO groups are converted with protective groups, so that no reaction of the isocyanate group takes place at usual storage conditions (e.g. 0 to 80° C.). By activation of the blocked isocyanates, e.g. by increased temperature (so-called deblocking temperature, e.g. >80° C.), the protective group can be cleaved under degeneration of the isocyanate groups. The blocking of isocyanates is known to the skilled person and described in the literature (see D. A. Wicks, Z. W. Wicks Jr., Progress in Organic Coating 36 (1999), 148-172). Suitable blocking agents of isocyanates are for example malonic acid ester, such as e.g. dimethylmalonate, acetoacetate, e.g. ethyl acetoacetate, β-diketones (e.g. 2,4-pentandione) and cyanoacetate; bisulfite (e.g. sodium bisulfite), phenol (e.g. 4-nitrophenol), pyridinol (e.g. 3-hydroxypyridin), thiophenol, mercaptopyridine (e.g. 2-mercaptopyridine), alcohol (e.g. 2-ethylhexylalcohol), N-hydroxy succinimide, oxime (e.g. methylethylketone oxime, 2-butanonoxime), amide (e.g. acetanilide, caprolactam), imide (e.g. succinimide), imidazole, amidine, guanidine, pyrazole (e.g. 3,5-dimethylpyrazole), triazoles (e.g. 1,2,4-triazole) or amine (e.g. piperidine, tert-butyl benzylamine).

At least one catalyst may optionally be added for the conversion of the isocyanate groups. Suitable for this purpose are for example all catalysts known to the skilled person that are used in polyurethane chemistry. To be considered in this case are for example organic, particularly tertiary aliphatic, cycloaliphatic or aromatic amines, and Lewis-acidic organic metal compounds. These include among others N,N′-dimethylaminoethanol, N,N′-dimethyl cyclohexylamine, 1,4-diazabicyclo[2.2.2]octane, tin(II)-2-ethylhexanoate, dibutyltin dilaurate and mixtures thereof.

The catalyst is preferably used in amounts of 0.0001 to 10 wt.-%, particularly preferred in an amount of 0.001 to 5 wt.-%, based on the mass of the polyisocyanate.

Preferably, pyrazole, oxime and benzylamine are used for the blocking of isocyanate groups, more preferably 3,5-dimethylpyrazole, 2-butanonoxime and tert-butylbenzylamine.

Preferably, 0.1 to 80%, more preferably 1 to 50%, even more preferably 1 to 30% of the NCO groups of the polyisocyanate are blocked.

Preferably, 0.1 to 50%, more preferably 5 to 40%, even more preferably 10 to 30% of the NCO groups of the polyisocyanate are blocked.

Preferably, the deblocking temperature is in the range of 80 to 180° C., more preferably in the range of 120 to 160° C.

One advantage of the reversible blocking reaction of isocyanate groups is the regeneration of a highly reactive functional group. For instance, it is for example able to improve the linkage of the core-shell particles to a substrate and thus also the abrasion and/or wash resistance.

The compound, comprising at least two groups with NCO-reactive hydrogen atom, is preferably selected from polyol (including diol), polyester polyol, polyether polyol, polyurea, amino- and/or hydroxy-functionalized homo- or copolymer, polyamine (including diamine), hydroxy-functional amine, polyurethane and/or polycarboxyilic acid. Polyether polyols are preferably based on C₂-C₅-alkylene oxide units, such as e.g. ethylene oxide, propylene oxide, butane oxide and/or pentane oxide units. Preferred are polyether polyols, polyethylene glycol and/or polypropylene glycol.

Polyester polyols preferably are reaction products of diols (e.g. 1,4-butanediol, diethylene glycol or 1,6-hexanediol) with dicarboxylic acids (e.g. glutaric acid, adipic acid or pimelic acid) and/or lactones (e.g. ε-caprolactone).

Hydroxy-functionalized polymers are preferably based on hydroxy-functional vinyl monomers e.g. 2-hydroxyethyl(meth)acrylate and 2-hydroxypropyl(meth)acrylate.

Suitable polyamines have at least two primary and/or secondary amines. Preferably, polyvinyl amine, diethylene triamine, pentaethylene hexamine, toluene diamine, piperazine, polyethyleneimine and mixtures thereof are used.

Preferred hydroxy-functional amines are ethanolamine or aminopropyl alcohol.

The compound comprising at least two groups with NCO-reactive hydrogen atom is preferably water-soluble (>10 g/l at 20° C.). The molar ratio of NCO groups to groups with NCO-reactive hydrogen atom, e.g. —OH, —NH₂, —NHR, preferably is between 1 and 100, preferably 2 and 100, more preferably 5 and 100 and even more preferably 5 and 80.

In a preferred embodiment, the addition product of the layer far from the core comprises about 1 to 50 mol-%, more preferably about 3 to 40 mol-% and even more preferably 5 to 20 mol-% of the compound, comprising at least two groups with NCO-reactive hydrogen atom, based on the amount of substance of the originally available free isocyanate groups.

In a preferred embodiment, the layer far from the core comprises at least 1 mol-%, preferably at least 2.5 mol-%, even more preferably at least 5 mol-% of polyols and/or polyamines, based on the amount of substance of the originally available free isocyanate groups.

The addition product of the layer far from the core preferably comprises about 40 to 99 wt.-% polyisocyanate, more preferably 60 to 99 wt.-%, even more preferably 70 to 99 wt.-%, even more preferably 80 to 99 wt.-% and most preferably about 90 to 99 wt.-% polyisocyanate based on the total mass of the layer far from the core.

In a further preferred embodiment, the layer far from the core has at least one additional functional group, preferably an anionic, cationic or non-ionic group or an ethylenically unsaturated group (e.g. vinyl, allyl or (meth)acryl group). The at least one additional functional group, particularly an anionic, cationic or non-ionic group, causes an improved dispersibility and dispersion stability of the core-shell particles in an aqueous environment.

Core-shell particles with ethylenically unsaturated groups in the layer far from the core can be polymerized or crosslinked by temperature treatment or treatment with energetic radiation. If necessary, expedients known to the skilled person, such as e.g. catalysts, initiators, photoinitiators, etc. may be used for better polymerization or crosslinking.

The anionic group preferably comprises at least one carboxylate, phosphate, phosphonate, sulfate, sulfonate group. More preferably, the anionic group comprises the formula (I)

-L-X formula (I)

wherein
X is SO₃⁻, SO₄⁻, COO⁻, PO₄²⁻ or PO₃²⁻, particularly SO₃⁻ or COO⁻, and
L is linear or branched, saturated or unsaturated C₁-C₁₀-alkylene, which is optionally substituted with —OH.

In the case of addition products of at least one polyisocyanate and at least one compound comprising at least two groups with NCO-reactive hydrogen atom, the functional anionic group can be introduced into the layer far from the core by reaction of an isocyanate group of the polyisocyanate with a compound having an isocyanate-reactive hydrogen atom besides an anionic group. The above-mentioned compounds preferably have the formula A-L-X, wherein L and X are as defined above and A preferably is OH, NH₂ or NHR.

Preferably, the functional cationic group is a quaternary ammonium ion or an ammonium salt and more preferably has the formula (II):

-L-Y formula (II)

wherein
Y is NHR₈R₉⁺ or NR₈R₉R₁₀⁺,
R₈, R₉ and R₁₀ are each independently of each other H or linear or branched, saturated or unsaturated, C₁-C₁₀-alkyl, which is optionally substituted with —OH and/or —COOH, and
L is as defined above.

In the case of an addition product of at least one polyisocyanate and at least one compound comprising at least two groups with NCO-reactive hydrogen atom, the cationic functional group is preferably introduced via a compound having a quaternary ammonium ion, secondary or tertiary amine, respectively, besides an isocyanate-reactive hydrogen atom. Preferred compounds are N-methyldiethanolamine and N,N-dimethylethanolamine. The amines may subsequently be converted to quaternary ammonium groups or ammonium ions by alkylation or protonation. Preferably, the amines are methylated. Suitable methods for alkylation and respective alkylating agents are known to the skilled person. Preferred alkylating agents are dimethyl sulfate, methyl chloride or methyl tosylate.

Preferred non-ionic functional groups comprise polyalkylene oxides, preferably polyethylene oxide and/or polypropylene oxide. Preferably, polyalkylene oxides with a weight average molecular weight of 200 to 2000 g/mol, more preferably 400 to 1000 g/mol are used. Preferred polyalkylene oxides are methyl-capped polyethylene glycol (MPEG), methyl-capped polypropylene glycol or methyl-capped poly(ethylene glycol/propylene glycol).

In the case of addition products of at least one polyisocyanate and at least one compound comprising at least two groups with NCO-reactive hydrogen atom, the functional non-ionic group can be introduced into the layer far from the core by reaction of an isocyanate group of the polyisocyanate with a compound having an isocyanate-reactive hydrogen atom besides a non-ionic group.

In the case of addition products of at least one polyisocyanate and at least one compound comprising at least two groups with NCO-reactive hydrogen atom, the functional ethylenically unsaturated group can be introduced into the layer far from the core by reaction of an isocyanate group of the polyisocyanate with a compound having an isocyanate-reactive hydrogen atom besides at least one ethylenically unsaturated group. Compounds having an isocyanate-reactive hydrogen atom besides at least one ethylenically unsaturated group preferably are (meth)acrylic acid, 2-hydroxyethyl(meth)acrylate, allylamine, acrylamide, diallylamine, pentaerythritol triacrylate and polymers containing one or more such compounds as comonomer. Particularly preferred here are compounds with one or more acrylate functions.

In a preferred embodiment, the additional functional group is covalently bound to the layer far from the core via a urethane group.

In the case of an addition product of at least one polyisocyanate and at least one compound comprising at least two groups with NCO-reactive hydrogen atom in the layer far from the core, up to 50%, more preferably 5-40%, even more preferably 10 to 30% of the originally available NCO groups in the polyisocyanate can be converted with a compound comprising at least one functional group.

In the case of an addition product of at least one polyisocyanate and at least one compound comprising at least two groups with NCO-reactive hydrogen atom in the layer far from the core, up to 30%, more preferably up to 20%, even more preferably 0.1 to 20% of the originally available NCO groups in the polyisocyanate can be converted with a compound comprising at least one functional group.

The layer far from the core and the layer close to the core can optionally be covalently linked to each other. Preferably, the layer close to the core and the layer far from the core are not covalently linked to each other. Surface-active reagent, particularly surfactant, defoamer, protective colloid or thickening agent can possibly be disposed between the layer far from the core and the layer close to the core. The compounds, which can mainly be disposed between the layer far from the core and the layer close to the core, for example make up 0 to 70 wt.-%, preferably 5 to 30 wt.-%, more preferably 10 to 15 wt.-% based on the total mass of the layer far from the core and the layer close to the core.

In a particularly preferred embodiment, the core-shell particle according to the invention comprises

(a) a core comprising at least one lipophilic compound and
(b) a shell comprising a layer close to the core and a layer far from the core.

In a particularly preferred embodiment, the core-shell particle consists of

(a) a core comprising at least one lipophilic compound,
(b) a shell comprising a layer close to the core and a layer far from the core and
(c) optionally at least one excipient, particularly surface-active reagent, preferably surfactant, binding agent, defoamer, protective colloid or thickening agent.

In a particularly preferred embodiment, the core-shell particle consists of

(a) a core comprising at least one lipophilic compound and
(b) a shell comprising a layer close to the core and a layer far from the core.

In a particularly preferred embodiment, the core-shell particle according to the invention comprises

(a) a core comprising at least one lipophilic compound and
(b) a shell comprising a layer close to the core and a layer far from the core, wherein the layer close to the core is obtainable by polymerization of at least one monomer with at least one ethylenically unsaturated group.

In a particularly preferred embodiment, the core-shell particle according to the invention comprises

(a) a core comprising at least one lipophilic compound and
(b) a shell comprising a layer close to the core and a layer far from the core, wherein the layer close to the core is obtainable by polymerization of at least one monomer with at least one ethylenically unsaturated group and the layer far from the core contains at least one urethane, allophanate, carbodiimide, isocyanurate, biuret, uretdione, urea, iminooxadiazinedione or uretonimine group and preferably is a polyurethane.

The weight ratio between the layer close to the core and the layer far from the core preferably is at 50:50 to 95:5 wt.-%, more preferably 70:30 to 90:10 wt.-% and most preferably 80:20 to 90:10 wt.-% based on the total mass of the layer close to the core and the layer far from the core.

The weight ratio of core:shell preferably is in the range of 50:50 to 95:5, preferably 70:30 to 90:10.

Preferably, the layer far from the core is permeable for the lipophilic compound. Methods for the determination of the permeability of the core-shell particles are known. Permeability can for example be determined via the loss of latent heat by means of differential scanning calorimetry (DSC) (also see examples).

The core-shell particles according to the invention are preferably spherical or ellipsoid, more preferably spherical.

The average diameter (D50) of the core-shell particles according to the invention preferably is 0.1 to 100 μm, more preferably 0.5 to 80 μm and even more preferably 1 to 75 μm (e.g. determined by laser diffraction).

A further aspect of the invention relates to a composition comprising at least one core-shell particle according to the invention. The composition preferably further comprises water.

In a preferred embodiment, the composition further comprises at least one expedient, particularly at least one surface-active reagent, particularly a surfactant, a binding agent, a defoamer, a protective colloid and/or a thickening agent.

Particularly non-ionic, anionic or cationic surfactants and/or mixtures thereof may be used as surface-active reagents. Preferred non-ionic surfactants are e.g. alkoxylation products of fatty acids, fatty acid esters, fatty acid amides, aliphatic alcohols and sugar derivatives. Preferably, ethoxylation products of linear or branched aliphatic alcohols with 6 to 22 carbon atoms are used.

Preferred cationic surfactants are quaternary ammonium salts, such as e.g. di-(C10-C24)-alkyl dimethyl ammonium chloride, (C10-C24)-alkyl dimethyl ethyl ammonium chloride or bromide, (C10-C24)-alkyl trimethyl ammonium chloride or bromide, (C10-C24)-alkyl dimethyl benzyl ammonium chloride, alkyl methyl poly(oxyethylene)ammonium chloride, bromide or monoalkylsulfate, salts of primary, secondary and tertiary fatty amines with 8 to 24 C-atoms with organic or inorganic acids, salts of ethoxylated primary and secondary fatty amines with 8 to 24 C-atoms with organic or inorganic acids, imidazolinium derivatives or esterquats. Preferred are di-(C10-C24)-alkyl dimethyl ammonium chloride, (C10-C24)-alkyl trimethyl ammonium chloride or bromide, salts of primary, secondary and tertiary fatty amines with 8 to 24 C-atoms with organic or inorganic acids and esterquats.

Anionic surfactants particularly are fatty alcohol sulfates such as e.g. sodium lauryl sulfate, alkyl sulfonates such as e.g. sodium lauryl sulfonate, alkyl benzene sulfonate, such as e.g. sodium dodecyl benzol sulfonate and fatty acid salts such as e.g. sodium stearate and phosphate ester, such as e.g. phosphate ester of aliphatic alcohols.

The surface-active reagents are preferably added in an amount of 0-10 wt.-%, more preferably 0 to 5 wt.-%, even more preferably 0 to 2 wt.-% based on the mass of the total composition.

Preferred protective colloids are preferably water-soluble polymers, for example polyvinyl alcohol, cellulose derivatives, particularly hydroxyalkyl cellulose or carboxyalkyl cellulose, gum arabic, polyacrylic acid, polyacrylamide, polyvinylpyrrolidone and/or maleic acid anhydride copolymers, particularly preferred is polyvinyl alcohol.

The protective colloid is preferably present in amounts of 0.01 to 20 wt.-%, more preferably 0.1 to 10 wt.-%, even more preferably 0.5 to 5 wt.-% based on the mass of the total composition.

Preferred binding agents are polymers with a glass transition temperature in the range of −45 to +45° C., particularly selected from polymers on the basis of (meth)acrylic acid ester, styrene, isoprene, butadiene, vinyl acetate and/or isocyanate. The binding agent is preferably present in amounts of 0.01 to 20 wt.-%, more preferably 0.01 to 5 wt.-% based on the mass of the total composition.

Preferred defoamers are selected from mineral oil, silicic acid, silicone-containing compounds, such as e.g. organosilicon compounds. The defoamer is preferably present in amounts of 0.01 to 10 wt.-%, more preferably 0.01 to 2 wt.-% based on the mass of the total composition.

The composition according to the invention preferably comprises 10 to 55 wt.-%, more preferably 15 to 45 wt.-%, even more preferably 20 to 37.5 wt.-% of the core-shell particles according to the invention based on the total mass of the composition.

A further aspect of the present invention is a method for preparing the core-shell particle or the composition according to the invention. The method comprises the steps:
(i) providing at least one lipophilic compound, optionally slurried in a carrier oil,
(ii) mixing the at least one lipophilic compound and optionally the carrier oil with
   at least one monomer with at least one ethylenically unsaturated group,
   water,
   at least one polymerization initiator,
   at least one protective colloid,
   optionally at least one surface-active reagent,
   optionally at least one chain regulator,
under formation of an emulsion, wherein the water forms the continuous phase.
(iii) treating the emulsion obtained in (ii) at elevated temperature while stirring,
(iv) adding at least one, optionally partially blocked, polyisocyanate and at least one compound comprising at least two groups with NCO-reactive hydrogen atom and optionally adding at least one compound comprising at least one functional group and an NCO-reactive hydrogen atom,
(v) optionally treating the mixture obtained in (iv) at elevated temperature,
(vi) optionally adding at least one binding agent, defoamer, surface-active reagent and/or a thickening agent and
(vii) optionally at least partially removing the water.

If the lipophilic compound is present as a solid at room temperature, step (i) is preferably carried out at temperatures above room temperature, particularly preferred at temperatures above the melting point of the lipophilic compound(s). Under these conditions, an emulsion particularly an oil-in-water-emulsion can form, wherein the water forms the continuous phase and the lipophilic compound(s) forms the disperse phase together with at least a portion of the monomer.

The protective colloid stabilizes the emulsion. The stabilization of the emulsion can further be improved by the addition of surface-active reagents. Protective colloids and surface-active reagents are as defined above and are used preferably in the respective amounts.

Preferred polymerization initiators are radical initiators, particularly a peroxide, an azo compound, a persulfate, a hydroperoxide and/or a redox initiator or mixtures thereof. The dissociation temperature of the polymerization initiators preferably lies above the melting point of the lipophilic compound, particularly at up to 50° C. above the melting point of the lipophilic compound. Suitable initiators may be azo compounds, such as e.g. 2,2′-azobis-(2-amidinopropane)dihydrochloride, 2,2′-azobis-(N,N-dimethylene)isobutyramidine dihydrochloride, 2-(carbamoylazo)isobutyronitrile, 4,4′-azobis-(4-cyanovalerianic acid), 2,2′-azobis[2-(2-imidazoline-2-yl)propane]dihydrochloride and 2,2′-azobis(2,4-dimethylvaleronitrile).

Suitable peroxide compounds are for example acetyl acetone peroxide, methyl ethyl ketone peroxide, tert-butyl hydroperoxide, cumene hydroperoxide, tert-amyl perpivalate, tert-butyl perpivalate, tert-butyl perneohexanoate, tert-butyl perisobutyrate, tert-butyl per-2-ethylhexanoate, tert-butyl perisononanoate, tert-butyl permaleate, tert-butyl perbenzoate, tert-butyl per-3,5,5-trimethylhexanoate and tert-amyl perneodecanoate as well as sodium peroxodisulfate or potassium peroxodisulfate.

Particularly preferred initiators are 2,2′-azobis[2-(2-imidazoline-2-yl)propane]dihydrochloride and 2,2′-azobis(2,4-dimethylvaleronitrile), the 10 hour half life of which is in the temperature range of 30 to 100° C. The initiator may be used as solid or solution. The polymerization initiators are usually used in amounts of 0.01 to 5 wt.-%, preferably 0.1 to 3.5 wt.-% based on the total mass of the monomers with at least one ethylenically unsaturated group.

The chain length of the polymers obtainable from monomers with at least one ethylenically unsaturated group can be regulated via chain regulators. Such chain regulators are known to the skilled person. Preferred chain regulators are sulfurous compounds, particularly thiols, particularly lauryl mercaptan or ethyl hexyl thioglycolate. The chain regulator is typically used in amounts of 0 to 4 wt.-%, more preferably 0.01 to 3 wt.-% based on the total mass of the monomers with at least one ethylenically unsaturated group.

After step (ii), the mixture is optionally further emulsified under shear forces, particularly by using a homogenizer, e.g. Ultra-Turrax® or Dispax®. The average droplet size (D50) of the disperse phase determined by means of light radiation is preferably from 0.1 to 100 μm, more preferably 0.5 to 80 μm, even more preferably 1 to 75 μm.

The emulsion obtained in step (ii) is subsequently treated in step (iii) at elevated temperature, preferably at 25 to 100° C., more preferably at 50 to 100° C., while stirring. The treatment step (iii) usually takes 0.5 to 8 hours, preferably 1 to 8 hours, more preferably 3 to 4 hours. After step (iii), preferably 90 to 100% of the monomers with at least one ethylenically unsaturated group are converted.

Step (ii) and step (iii) are preferably carried out under a protective gas atmosphere, particularly under nitrogen or argon.

By the radical polymerization, a polymer is formed in situ at the interface between disperse phase and continuous phase. This results in preferably spherical or ellipsoid particles from cores, which are surrounded by the layer close to the core. The thus obtained particles preferably have a diameter D50 of 0.1 to 100 μm, preferably 0.5 to 80 μm, more preferably 1 to 75 μm.

In step (iv), at least one—optionally partially blocked—polyisocyanate and at least one compound comprising at least two groups with NCO-reactive hydrogen atom are added to the particles dispersed in the continuous phase from step (iii). Optionally, in this step, at least one compound comprising at least one functional group and one NCO-reactive hydrogen atom is added. The latter compound is particularly added if a functional layer far from the core is to be obtained. Alternatively, the polyisocyanate may also already contain at least one functional group. Step (iv) usually takes place at temperatures of 25 to 100° C., preferably 50 to 100° C.

In step (iv), the optionally partially blocked polyisocyanate orients towards the layer close to the core surrounding the core. By the subsequent addition of the compound comprising at least two groups with NCO-reactive hydrogen atom, a layer far from the core is formed on the layer close to the core.

In step (v), the mixture obtained in step (iv) is optionally thermally treated at elevated temperature. Step (v)—if carried out—preferably takes place at temperatures of 25 to 100° C., preferably 30 to 90° C. The reaction time preferably is 0.25 to 4 hours. Under these conditions, preferably 90 to 100%, more preferably 95 to 100% of all NCO groups are converted.

In a preferred embodiment, there is no chemical reaction between the layer close to the core and the layer far from the core, which would possibly lead to a covalent linkage of the layer close to the core and the layer far from the core.

After reaction took place in step (iv) or (v), expedients such as binding agents, defoamers, surface-active reagent and/or thickening agents can optionally be added.

After step (iv) or step (v), respectively, a composition according to the invention comprising the core-shell particles according to the invention and water is obtained. The obtained composition forms a stable dispersion. Therein, the core-shell particles have a diameter D50 of 0.1 to 100 μm, preferably 0.5 to 80 μm, more preferably of 1 to 75 μm.

After step (vi), it is optionally possible to equalize the particle size distribution via filtration steps.

The core-shell particles can optionally be isolated in step (vii) by the methods known to the skilled person, by at least partially removing the water. Preferred methods are centrifugation, filtration, distillation and/or spray drying. Isolated core-shell particles can for example be incorporated into a composition as slurry or powder.

In a further aspect, the present invention is directed to core-shell particles obtainable by the method described above.

The core-shell particles and compositions according to the invention can be used in a variety of technical fields. For instance, they can for example be used for the functionalization of materials, particularly fibers, textile fabrics, paint, varnish, construction materials, plastics and/or plastic foams. One aspect of the present invention thus is the use of the core-shell particles according to the invention or the composition according to the invention for the functionalization of materials, particularly fibers, textile fabrics, construction materials, plastics or plastic foams, for example polyurethane, polystyrene, latex and melamine resin foams, paint and varnish.

Particularly fibers or textile materials, such as textile fabrics, nonwovens (for example fleeces or filters) are to be understood as textiles. In order to functionalize textile fibers, the core-shell particles can be added to a melting or in the form of an aqueous dispersion to the fiber matrix and used in a spinning process, for example in a melt spinning process or a wet spinning process.

“Fibers” refers to natural fibers as well as artificial fibers. “Natural fibers” preferably contain cotton, wool and/or silk. “Synthetic fibers” or “artificial fibers” are synthetically produced from natural and/or synthetic polymers and preferably contain polyester, polyolefin, e.g. preferably polyethylene or polypropylene, more preferably polypropylene, polyamide, polyaramide, such as e.g. Kevlar® and Nomex®, polyacrylonitrile, spandex and/or viscose.

Particularly fibers or textile materials are to be understood as textiles. A “textile” is made from several fibers and preferably is linear or flat. “Linear textile” for example refers to a yarn, a twine or a rope. “Flat textiles” preferably are fleeces, felts, fabrics, knitted fabrics and nettings. Textiles may contain natural fibers and synthetic fibers or mixtures thereof.

A further subject-matter of the present invention is a method for the finishing of materials, particularly of textiles, comprising the steps

(a) providing the core-shell particles or compositions according to the invention,
(b) applying the core-shell particles or compositions according to the invention to a material; and
(c) thermally treating the material.

The application of the core-shell particles or the composition e.g. by soaking the textile, particularly the textile material, in step (b) generally takes place with layers of 0.1 to 3 wt.-%, preferably 1 to 8 wt.-%, particularly preferred 1 to 6.5 wt.-% solid content based on the weight of the textile to be treated. Usually, for this purpose, an aqueous composition is prepared in the desired concentration. The concentration of the composition is thereby selected such that the respective desired amount results. Further preparation agents can be added to the composition. Additional preparation agents may for example be chemicals for anti-wrinkle finishing (e.g. methylol compounds of the dihydroxy ethylene urea or methylol melamine ether with different methylolation degrees), flame retardants or softeners.

The composition is applied to the material, particularly the textile material by common methods known to the skilled person, e.g. by forced application, exhaust methods, spraying, soaking, slop padding, printing, coating, for example by transfer coating or rotary printing, or padding.

In a preferred embodiment, the composition according to the invention is applied by soaking the material and subsequent squeezing on the foulard.

The drying and thermal treatment of the material obtained in step (b) is carried out in step (c) preferably at temperatures between 130 and 170° C. The treatment preferably takes place in the tenter frame dryer. At the given temperatures, the blocking groups—if present—also cleave and evaporate. The resulting reactive isocyanate group reacts with isocyanate-reactive hydrogen atoms of the material and/or the further components, so that the core-shell particles are covalently bound to the material. The thermal treatment of the material preferably occurs in 0.5 to 10 minutes, particularly preferred in 1 to 5 minutes. The duration of the thermal treatment is thereby also dependent on the applied temperatures.

The present invention thus also relates to materials, particularly fibers or textile materials comprising the core-shell particles according to the invention or the composition according to the invention.

The core-shell particles and the composition, respectively, according to the present invention can also be used in construction materials, for the production of polymeric molded articles and/or in polymeric coating materials. Preferably, the core-shell particles according to the invention are used as functional additive in mineral coating materials such as for example plaster or in wall paint. The core-shell particles according to the invention are particularly suitable in the functionalization of polymeric molded articles and polymeric coating materials made of thermoplastic and thermosetting plastics, during the processing of which the core-shell particles are not destroyed. Examples for thermoplastic and thermosetting plastics are epoxy resins, urea resins, melamine resins, polyurethane and silicone resins, but also varnish.

It has turned out that the core-shell particles according to the invention can easily and variably be functionalized, without influencing the primary properties of the core-shell particles, such as e.g. permeability and mechanical stability. According to the invention, the permeability and mechanical stability of the particles is variably adjusted via the layer close to the core. The layer close to the core is thereby preferably made of a material that is inert to the core. The layer far from the core can variably be functionalized.

Since there preferably are no interactions, particularly no covalent interactions between the layer close to the core and the layer far from the core, the layer far from the core does not influence the property profile of the layer close to the core. The core-shell particles according to the invention as well as the method according to the invention further enable a modular system, wherein the cores surrounded by the layer close to the core can be provided in stock and subsequently be modified with different functional groups via the layer far from the core as desired, without the properties of the core surrounded by the layer close to the core (primary particle) changing.

The present invention is explained in more detail by means of examples, whereas the invention is not limited to these examples.

### Used Materials

| | | |
|---|---|---|
| Parafol 18-97 | Techn. n-octadecane (97% | Sasol |
| | purity) | |
| Laromer TMPTA | Trimethylol propane triacrylate | BASF |
| WAKO V-65B | 2,2′-azobis(2,4- | WAKO Chemicals |
| | dimethylvaleronitrile) | |
| WAKO VA-044 | 2,2′-azobis[2-(2-imidazoline-2- | WAKO Chemicals |
| | yl)propane]dihydrochloride | |
| Desmodur I | Isophorone diisocyanate | Covestro |
| 3,5- | 3,5-Dimethylpyrazole | Wacker |
| Dimethylpyrazole | | |
| Heavy | Complex mixture of linear, | Dow Deutschland |
| Polyamine XE | cyclic and branched ethylene | |
| | amines (amine content 33-38%) | |
| Plextol R272 | Binding agent - self- | Synthomer |
| | crosslinking anionic | |
| | polyacrylate copolymer (45% | |
| | dry substance DS) | |
| Lutensit A-BO | Emulsifier (sulfosuccinate) | BASF |
| | (75% DS) | |
| Strodex PK90 | Emulsifier (phosphate coester | Ashland |
| | of aliphatic alcohols) (90% DS) | |
| Silfoam SE47 | Silicone defoamer (17.5% DS) | Wacker |
| Rohagit SD15 | Thickening agent (polyacrylate | Synthomer |
| | copolymer acrylic acid co-ethyl | |
| | acrylate) | |
| | (30% DS) | |
| Exxsol D100 | Hydrocarbons, C12-C15, n- | ExxonMobil |
| ULA | alkanes, isoalkanes, cyclic | |
| Visiomer MPEG | Methoxypolyethyleneglycol- | Evonik |
| 750 MA | 750-methacrylate (50% in | |
| | water) | |
| Disponil A 3065 | Emulsifier (mixture of | BASF |
| | ethoxylated linear fatty | |
| | alcohols) (65% DS) | |
| Arquad 2.10-50 | Emulsifier (Didecyl dimethyl | Nouryon |
| | ammonium chloride) (50% DS) | |
| BYK 7420 ES | Thickening agent (modified | BYK |
| | urea) (40% DS) | |
| DISPERBYK 192 | Emulsifier (copolymer with | BYK |
| | pigment-affine groups) (100% | |
| | DS) | |

### EXAMPLE-1

### Partial Blocking of Isocyanate Groups

40.00 g isopropyl acetate and 10.00 g (44.98 mmol) isophorone diisocyanate (IPDI) were presented in a round-bottom flask under nitrogen atmosphere.

While stirring, 2.60 g (27.05 mmol) 3,5-dimethylpyrazole were added and mixed until a homogeneous solution was formed. The mixture was heated to 40° C. and after reaching a constant NCO content was subsequently freed from the solvent under vacuum distillation.

### Preparation of the Core-Shell Particles

### Aqueous Phase:

| | | |
|---|---|---|
| 530.75 | g | Water |
| 80.20 | g | Polyvinyl alcohol solution (12.5 wt.-%, 88% saponified, |
| | | medium molar weight 128000 g/mol) |

### Oily Phase:

| | | |
|---|---|---|
| 286.22 | g | Parafol 18-97 |
| 37.50 | g | Methylmethacrylate |
| 16.55 | g | Laromer TMPTA |
| 0.49 | g | Lauryl mercaptan |
| 1.00 | g | WAKO V-65B |

### Aqueous Initiator:

| | |
|---|---|
| 4.97 g | Water |
| 0.99 g | WAKO VA-044 |

### Isocyanate:

| | |
|---|---|
| 12.71 g | 30% partially blocked Desmodur I |

### Polyamine:

| | |
|---|---|
| 6.23 g | 10% Heavy Polyamine XE solution |

### Stabilization:

| | | |
|---|---|---|
| 2.95 | g | Lutensit A-BO |
| 3.00 | g | Strodex PK-90 |
| 3.84 | g | Silfoam SE 47 |
| 10.97 | g | Rohagit SD 15 |
| 1.63 | g | Sodium hydroxide solution (50%) |

In a beaker, water as well as the protective colloid were presented and heated to 40° C. while stirring. The oily phase was separately melted and pre-mixed and then introduced into the water phase while stirring. Subsequently, the emulsion was sheared for 5 min with a rotor-stator-homogenizer. The warm emulsion was transferred to a flask, tempered at 40° C., constantly stirred via a propeller stirrer and thereby, the reaction mixture was flushed with nitrogen. After exchanging the atmosphere for nitrogen, the reaction vessel was sealed with a pressure compensation and heated to 60° C. while stirring. Held at 60° C. for 20 min, then heated to 65° C., again held for 20 min and finally heated to 70° C. and held for 60 min. After this time, an aqueous solution of the aqueous initiator was added to the resulting dispersion under protective gas and again stirred for 60 min.

The partially blocked polyisocyanate was dropped into this suspension and stirred in. Subsequently, the polyamine was added drop by drop and the temperature was raised to 80° C. After 2 h reaction time, the dispersion was cooled to room temperature, mixed with emulsifiers, defoamer as well as thickening agent and adjusted to pH 8.5 with sodium hydroxide solution. A dispersion with about 34% solids content was obtained.

### EXAMPLE-2

### Partial Blocking of Isocyanate Groups

40.00 g isopropyl acetate and 12.00 g (44.98 mmol) isophorone diisocyanate (IPDI) were presented in a round-bottom flask under nitrogen atmosphere. While stirring, 10.80 g (10.80 mmol) Jeffamine M1000 were added and mixed until a homogeneous solution was formed. The mixture was heated to 50° C. and after reaching a constant NCO content was subsequently freed from the solvent under vacuum distillation.

### Preparation of the Core-Shell Particles

### Water Phase:

| | | |
|---|---|---|
| 488.93 | g | Water |
| 71.17 | g | Polyvinyl alcohol solution (12.5 wt.-%, 88% saponified, |
| | | medium molar weight 128000 g/mol) |

### Oily Phase:

| | | |
|---|---|---|
| 279.39 | g | Parafol 18-97 |
| 39.89 | g | Methylmethacrylate |
| 17.66 | g | Laromer TMPTA |
| 0.46 | g | Lauryl mercaptan |
| 0.92 | g | WAKO V-65B |

### Aqueous Initiator:

| | |
|---|---|
| 4.57 g | Water |
| 0.96 g | WAKO VA-044 |

### Isocyanate:

| | |
|---|---|
| 20.38 g | 10% partially functionalized Desmodur I |

### Polyamine:

| | |
|---|---|
| 3.67 g | 10% Heavy Polyamine XE solution |

### Stabilization:

| | | |
|---|---|---|
| 49.78 | g | Plextol R272 |
| 3.93 | g | Lutensit A-BO |
| 3.15 | g | Strodex PK-90 |
| 3.54 | g | Silfoam SE 47 |
| 10.10 | g | Rohagit SD 15 |
| 1.50 | g | Sodium hydroxide solution (50%) |

The sample was prepared analogously to Example 1. Additionally, a binding agent was added to the dispersion. A dispersion with about 40% solids content was obtained.

### EXAMPLE-3

Preparation of the Dispersion with Decreased Ratio of Crosslinking Agent in the Layer Close to the Core

### Water Phase:

| | | |
|---|---|---|
| 439.64 | g | Water |
| 78.65 | g | Polyvinyl alcohol solution (12.5 wt.-%, 88% saponified, |
| | | medium molar weight 128000 g/mol) |

### Oily Phase:

| | | |
|---|---|---|
| 195.53 | g | Parafol 18-97 |
| 35.63 | g | Methylmethacrylate |
| 11.50 | g | Laromer TMPTA |
| 0.41 | g | Lauryl mercaptan |
| 0.83 | g | WAKO V-65B |

### Aqueous Initiator:

| | | |
|---|---|---|
| 4111 | g | Water |
| 0.86 | g | WAKO VA-044 |

### Isocyanate:

| | |
|---|---|
| 8.77 g | Desmodur I |

### Polyamine:

| | |
|---|---|
| 6.74 g | 10% Heavy Polyamine XE solution |

### Stabilization:

| | | |
|---|---|---|
| 199.06 | g | Plextol R272 |
| 2.32 | g | Lutensit A-BO |
| 2.34 | g | Strodex PK-90 |
| 3.18 | g | Silfoam SE 47 |
| 9.08 | g | Rohagit SD 15 |
| 1.35 | g | Sodium hydroxide solution (50%) |

The sample was prepared analogously to Example 1. A dispersion with about 36% solids content was obtained.

The permeability of the core-shell particles was determined via the loss of latent heat by means of differential scanning calorimetry (DSC). For this purpose, a latent heat storage material was covered and the dispersion was finished on a textile fabric in dilution.

A part of the textile was dried at 20° C. for 24 h, while another part was dried at 150° C. for 3 min. The difference in the measured melting enthalpy between air-dried and heat-dried sample yields the tightness. For the reproducibility of the influence of the multiple layers that lead to the overall design of the shell, this DSC method was carried out for the same sample at different points of time of the method. For instance, the permeability was determined e.g. after formation of the polyacrylate layer close to the core and then again after positioning the polyurethane layer far from the core.

| | | Remaining latent heat |
|---|---|---|
| | Remaining latent heat | on textile - layer close |
| | on textile - only layer | to the core and layer far |
| Sample | close to the core | from the core |
| Example 1 | 91.9% | 90.3% |
| Example 2 | 87.5% | 93.7% |
| Example 3 | 64.5% | 63.8% |

The results show that the permeability is given by the layer close to the core and is not or only slightly influenced by the layer far from the core. The layer far from the core is primarily responsible for the functionalization.

### EXAMPLE-4

Example 4 was carried out—as described in Example 1—whereas the partially blocked isocyanate was varied as follows.

Functionalization with Cationic Emulsifying Groups

75.00 g isopropyl acetate and 12.00 g (53.981 mmol) isophorone diisocyanate (IPDI) were presented in a round-bottom flask under nitrogen atmosphere. While stirring, 0.962 g (10.796 mmol) N,N-dimethyl amino ethanol as well as 0.008 g (0.0071 mmol) 1,4-diazabicyclo[2.2.2]octane (DABCO) were added and mixed until a homogeneous solution was formed. The mixture was heated to 50° C. and subsequently freed from the solvent under vacuum distillation.

The exact composition is shown in Table 1.

### EXAMPLE-5

Example 5 was carried out, as described in Example 1, whereas the oily phase was pre-mixed without acrylate crosslinker. The exact composition is given in Table 1. Without acrylate crosslinker, a sufficient tightness of the layer close to the core cannot be ensured.

### EXAMPLE-6

Example 6 was carried out—as described in Example 1—whereas the partially blocked isocyanate was varied as follows.

Functionalization with Radiation Crosslinkable Groups

75.00 g isopropyl acetate and 12.00 g (53.981 mmol) isophorone diisocyanate (IPDI) were presented in a round-bottom flask under nitrogen atmosphere. While stirring, 2.507 g (21.592 mmol) 2-hydroxethylacrylate as well as 0.024 g (0.0213 mmol) 1,4-diazabicyclo[2.2.2]octane (DABCO) were added and mixed until a homogeneous solution was formed. The mixture was heated to 50° C. and subsequently freed from the solvent under vacuum distillation.

The exact composition is given in Table 1.

### EXAMPLE-7

### Preparation of the Core-Shell Particles

In a beaker, water as well as the protective colloid were presented. The oily phase was separately pre-mixed and then introduced into the water phase while stirring. Subsequently, the emulsion was sheared for 5 min with a rotor-stator-homogenizer. The emulsion was transferred to a flask, constantly stirred via a propeller stirrer and thereby, the reaction mixture was flushed with nitrogen. After exchanging the atmosphere for nitrogen, the reaction vessel was sealed with a pressure compensation and heated to 60° C. while stirring. Held at 60° C. for 20 min, then heated to 65° C., again held for 20 min and finally heated to 70° C. and held for 60 min. After this time, an aqueous solution of the aqueous initiator was added to the resulting dispersion under protective gas and again stirred for 60 min.

The polyisocyanate was dropped into this suspension and stirred in. Subsequently, the polyamine was added drop by drop and the temperature was raised to 80° C. After 2 h reaction time, the dispersion was cooled to room temperature, mixed with emulsifiers, defoamer as well as thickening agent and adjusted to pH 8.5 with sodium hydroxide solution.

The exact composition is given in Table 1.

### Comparative Examples 1 and 2

The following comparative examples are prepared analogously to Example 1, whereas the synthesis ends before the addition of an isocyanate component, since the comparative particles are single-walled core-shell particles. The compositions of the comparative examples are shown in Table 1.

In a beaker, water as well as the protective colloid were presented and heated to 40° C. while stirring. The oily phase was separately melted and pre-mixed and then introduced into the water phase while stirring. Subsequently, the emulsion was sheared for 5 min with a rotor-stator-homogenizer. The warm emulsion was transferred to a flask, tempered at 40° C., constantly stirred with a propeller stirrer and flushed with nitrogen. After exchanging the atmosphere for nitrogen, the reaction vessel was sealed with a pressure compensation and heated to 60° C. while stirring. Held at 60° C. for 20 min, then heated to 65° C., again held for 20 min and finally heated to 70° C. and held for 60 min. After this time, an aqueous solution of the aqueous initiator was added to the resulting dispersion under protective gas and again stirred for 60 min. After this time, the dispersion was cooled to room temperature, mixed with emulsifiers, defoamer as well as thickening agent and adjusted to pH 8.5 with sodium hydroxide solution.

The obtained dispersions were analogously tested for their permeability behavior (see Table 2).

TABLE 1
Composition of Examples 4-7 according to the invention and comparative examples 1 and 2

| | Comparative | | Comparative | | | |
|---|---|---|---|---|---|---|
| | example 1 | Example 4 | example 2 | Example 5 | Example 6 | Example 7 |
| Polyvinyl alcohol | 66.80 | 65.43 | 66.23 | 66.94 | 64.84 | 73.49 |
| solution | | | | | | |
| distilled water | 442.09 | 432.87 | 438.26 | 443.00 | 450.96 | 495.19 |
| WAKO V-65B | 0.83 | 0.92 | 0.82 | 0.83 | 1.34 | 1.36 |
| Monomer 1 | 32.48^{a} | 32.26^{a} | 32.20^{a} | 47.49^{a} | 31.94^{a} | 35.68^{a} |
| Lauryl mercaptan | 0.42 | 0.50 | 0.41 | 0.41 | 0.45 | 0.51 |
| Core material | 264.90^{b} | 259.34^{b} | 262.61^{b} | 253.48^{b} | 257.24^{b} | 280.73^{c} |
| Laromer TMPTA | 14.52 | 14.15 | 14.39 | 0.00 | 14.10 | 16.50 |
| Monomer 2 | 3.25^{d} | 0.00 | 0.62^{e} | 0.00 | 0.00 | 0.00 |
| distilled water | 4.14 | 4.05 | 4.10 | 4.09 | 6.45 | 7.31 |
| WAKO VA-044 | 0.87 | 0.85 | 0.86 | 0.93 | 0.89 | 1.01 |
| Isocyanate | 0.00 | 9.33^{f} | 0.00 | 9.55^{g} | 10.40^{h} | 9.75^{g} |
| distilled water | 0.00 | 0.00 | 0.00 | 0.00 | 2.15 | 2.44 |
| 10% Heavy Polyamine | 0.00 | 2.96 | 0.00 | 3.21 | 3.85 | 4.37 |
| XE solution | | | | | | |
| PLEXTOL R 272 | 149.82 | 146.73 | 148.52 | 150.13 | 135.88 | 49.57 |
| Emulsifier 1 | 3.56ⁱ | 9.86^{j} | 9.98^{j} | 3.57ⁱ | 3.46ⁱ | 3.92ⁱ |
| Emulsifier 2 | 2.83^{k} | 4.81^{l} | 4.87^{l} | 2.84^{k} | 2.75^{k} | 3.12^{k} |
| SILFOAM SE 47 | 3.00 | 2.94 | 2.98 | 3.01 | 3.11 | 3.52 |
| Thickening agent | 9.13^{m} | 5.29ⁿ | 5.36ⁿ | 9.15^{m} | 8.87^{m} | 10.05^{m} |
| Expedient 1 | 1.37^{o} | 5.29^{p} | 5.36^{p} | 1.37^{o} | 1.33^{o} | 1.50^{o} |
| Expedient 2 | 0.00 | 2.41^{q} | 2.43^{q} | 0.00 | 0.00 | 0.00 |

^{a}methylmethacrylate
^{b}Parafol 18-97
^{c}1:10 mixture of Exxsol D100 ULA and C.I. Pigment Black 7
^{d}Visiomer MPEG 750 MA
^{e}N,N-dimethylaminoethylmethacrylate
^{f}Desmodur I partially blocked with 10 mol % dimethylaminoethanol
^{g}Desmodur I
^{h}Desmodur I partially blocked with 20 mol % 2-hydroxyethylacrylate
ⁱLutensit A-BO
^{j}Disponil A 3065
^{k}Strodex PK-90
^{l}Arquad 2.10-50
^{m}Rohagit SD 15
ⁿBYK 7420 ES
^{o}Sodium hydroxide solution 50%
^{p}hexylene diglycol
^{q}DISPERBYK 192

TABLE 2
Type of functionalization and permeability of the core-shell particles
according to the invention and the comparative particles

| | | | Remaining latent | |
|---|---|---|---|---|
| | | Remaining latent | heat on textile - | |
| | | heat on textile - | layer close to the | Solids content |
| | | only layer close | core and layer far | of the |
| Example | Functionalization | to the core | from the core | dispersion [%] |
| Example 1 | double wall with blocked | 91.90% | 90.30% | 34% |
| | isocyanate groups | | | |
| Example 2 | double wall with non-ionic | 87.50% | 93.70% | 40% |
| | emulsifying groups | | | |
| Example 3 | double wall decreased | 64.50% | 63.8% | 36% |
| | acrylate crosslinker | | | |
| Comparative | non-ionic emulsifying | 45.35% | / | 40% |
| example 1 | groups | | | |
| Example 4 | double wall with cationic | 89.30% | 89.00% | 40% |
| | emulsifying groups | | | |
| Comparative | Cationic emulsifying | 64.37% | / | 40% |
| example 2 | groups | | | |
| Example 5 | double wall without | 0.00% | 0.00% | 40% |
| | acrylate crosslinker | | | |
| Example 6 | double wall with | 86.30% | 87.20% | 39% |
| | radiation-curing groups | | | |
| Example 7 | double wall with | / | / | 13% |
| | encapsulation of black dye | | | |

The following items are subject-matter of the present invention
1. Core-shell particles comprising
   (a) a core comprising at least one lipophilic compound and
   (b) a shell comprising at least one layer close to the core and one layer far from the core.
2. The core-shell particles of item 1, wherein the layer far from the core is disposed on the layer close to the core.
3. The core-shell particles of item 1 or 2, wherein the layer close to the core surrounds the core.
4. The core-shell particles of one of the preceding items, wherein the core is solid at room temperature (20° C.).
5. The core-shell particles of one of items 1-3, wherein the core is liquid, preferably present as solution, emulsion or suspension, or is solid, preferably present as powder, at room temperature (20° C.).
6. The core-shell particles of one of the preceding items, wherein the lipophilic compound has a water solubility of <10 g/l, preferably <5 g/l, more preferably <3 g/l at 20° C.
7. The core-shell particles of one of the preceding items, wherein the lipophilic compound is selected from pigments, dyes, fragrances, cosmetics, flame retardants, latent heat storage materials, biocides, catalysts, adhesives, adhesive components, hydrophobing agents, polymer building blocks, isocyanates, oils, silicone oils, waxes or mixtures thereof.
8. The core-shell particles according to item 7, wherein the latent heat storage material is selected from
   saturated or unsaturated, linear, branched or cyclic hydrocarbon, preferably saturated or unsaturated, linear, branched or cyclic C₁₀-C₄₀-hydrocarbon, more preferably linear or cyclic C₁₀-C₄₀-alkane and aromatic C₆-C₂₀ hydrocarbon, most preferably n-hexadecane, n-heptadecane, n-octadecane, n-nonadecane, n-eicosane, cyclohexane, cyclooctane, cyclodecane, benzene, naphthalene, biphenyl,
   saturated or unsaturated C₆-C₃₀-fatty acid, saturated or unsaturated C6-C30-fatty alcohol and saturated or unsaturated C₆-C₃₀-fatty acid-C₁-C₁₀-alkyl ester, preferably lauric, stearic, oleic or behenic acid, lauryl, stearyl or oleyl alcohol, propyl palmitate, methyl stearate or methyl palmitate, and
   mixtures thereof.
9. The core-shell particles of item 7, wherein the dye is selected from reactive dye, such as e.g. C.I. Reactive Red 2, disperse dye, such as e.g. C.I. Disperse Yellow 42, acid dye, such as e.g. C.I. Acid Blue 1, or basic dye, such as e.g. C. Basic Violet 3, and mixtures thereof.
10. The core-shell particles of item 7, wherein the pigments are selected from organic or inorganic pigments, particularly color pigments, magnetic pigments, and mixtures thereof.
11. The core-shell particles of item 7, wherein the fragrances are selected from synthetic or natural fragrances.
12. The core-shell particles of item 7, wherein the flame retardants are halogenated flame retardants, preferably tetrabromobisphenol A (TBA), bromopolystyrene, chlorinated paraffins and dibromoneopentylglycol (DBNPG), phosphoric flame retardants, preferably organic phosphoric acid ester or cyclic phosphate derivatives, or mixtures thereof.
13. The core-shell particles of item 7, wherein the biocides are selected from pesticides, fungicides, herbicides, insecticides, algicides, molluscicides, acaricides, rodenticides, bactericides, antibiotics, antiseptics, antibacterial, antiviral, antifungal, antiparasitic biocides and mixtures thereof.
14. The core-shell particles of item 7, wherein the cosmetics are selected from anti-wrinkle agents, radical quenchers, self-tanning agents and/or massage oils.
15. The core-shell particles of one of the preceding items, wherein the layer close to the core is obtainable by polymerization of at least one monomer with at least one ethylenically unsaturated group.
16. The core-shell particles of item 15, wherein the monomer with at least one ethylenically unsaturated group does not have a nucleophilic group with active hydrogen atom, particularly no NCO-reactive hydrogen.
17. The core-shell particles of item 15 or 16, wherein the layer close to the core is obtainable by radical polymerization.
18. Core-shell particle of one of items 15-17, wherein the ethylenically unsaturated group is a vinyl, vinyl ether, acryl, C1-6-alkyl acryl, allyl and/or allyl ether group.
19. The core-shell particles of one of items 15-18, wherein the monomer with at least one ethylenically unsaturated group has the structure:

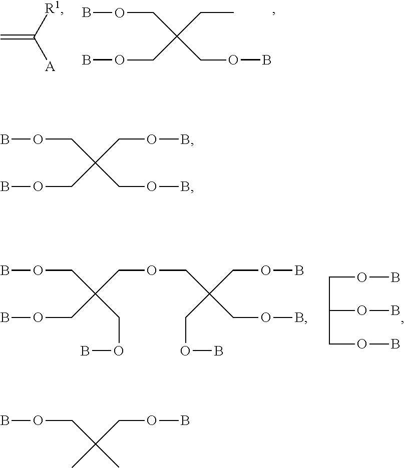

with

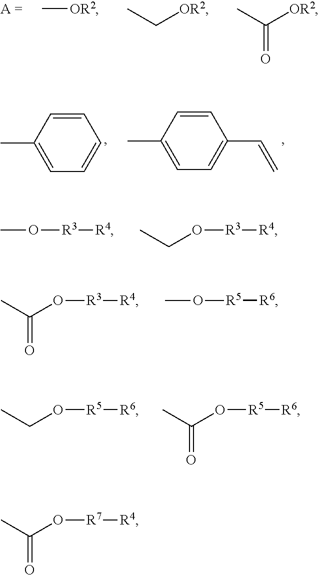

B=—R⁵-R⁶
R¹=—C₁-C₆-alkyl or —H, preferably —H or —CH₃,
R²=linear or branched C₁-C₂₄-alkyl,
R³=linear or branched C₁-C₂₄-alkylene,

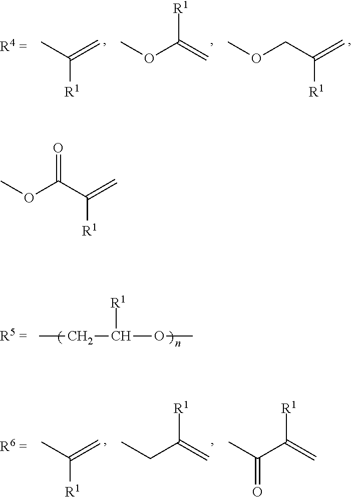

R⁷=polyester, particularly obtainable by reaction of C₁-C₆-alkyldiols and C₁-C₆-alkyldicarboxyilic acids, such as e.g. diester, e.g. malonic acid ester, oxalic acid ester, succinic acid ester, glutaric acid ester or adipic acid ester, and
n=0-20
20. The core-shell particles of one of items 15-19, wherein the molar ratio of monomers with one ethylenically unsaturated group to monomers with several ethylenically unsaturated groups is 2 to 40, preferably 4 to 30.
21. The core-shell particles of one of the preceding items, wherein the layer far from the core contains at least one urethane, allophanate, carbodiimide, isocyanurate, biuret, uretdione, urea, iminooxadiazinedione or uretonimine group.
22. The core-shell particles of one of the preceding items, wherein the layer far from the core is an addition product of at least one polyisocyanate and at least one compound comprising at least two groups with NCO-reactive hydrogen atom, preferably hydroxy, amino, carboxylic acid, urethane and/or urea groups.
23. The core-shell particles of item 22, wherein the polyisocyanate is aromatic, acyclic or aliphatic, preferably selected from methylene diphenyl isocyanate (MDI), polymeric MDI, toluylene diisocyanate (TDI), triphenylmethane-4,4′,4″-triisocyanate, 2,4,6-triisocyanatetoluene, isophorone diisocyanate (IPDI), 4,4′-methylenebis(cyclohexyl isocyanate) (H12MDI), methyl-2,4-cyclohexanediisocyanate, 1,3,5-triisocyanatecyclohexane, 1,3,5-trimethylisocyanatecyclohexane, trimethylene diisocyanate, 1,4,8-triisocyanateoctane, 1,3,6-triisocyanatehexane, hexamethylene diisocyanate, xylene diisocyanate (XDI), biuret-containing and isocyanurate-containing polyisocyanates.
24. The core-shell particles of item 22 or 23, wherein the NCO groups of the polyisocyanate are partially blocked.
25. The core-shell particles of item 23, wherein 0.1 to 80%, preferably 1 to 50%, more preferably 1 to 30% of the NCO groups of the polyisocyanate are blocked.
26. The core-shell particles of one of items 22-25, wherein the compound comprising at least two groups with NCO-reactive hydrogen atom is selected from polyols, polyester polyols, polyether polyols, polyureas, amino- and/or hydroxy-functionalized homo- or copolymers, polyamines and hydroxy-functionalized amines.
27. The core-shell particles of one of items 22-26, wherein the molar ratio of NCO groups to groups with NCO-reactive hydrogen atom lies between 1 and 100, preferably 2 and 100, more preferably 5 and 100 and even more preferably 5 and 80.
28. The core-shell particles of one of the preceding items, wherein the layer far from the core has at least one functional group, preferably an anionic, cationic or non-ionic group.
29. The core-shell particles of item 28, wherein the anionic group comprises at least one carboxylate, phosphate, phosphonate, sulfate or sulfonate group and preferably has the formula (I):

-L-X formula (I)

wherein
X is SO₃⁻, SO₄⁻, COO⁻, PO₄²⁻ or PO₃²⁻, and
L is linear or branched, saturated or unsaturated C₁-C₁₀ alkylene, which is optionally substituted with —OH.
30. The core-shell particles of item 28, wherein the cationic functional group comprises at least one quaternary ammonium ion or an ammonium salt and preferably has the formula (II):

-L-Y formula (II)
wherein
Y is NHR₈R₉⁺ or NR₈R₉R₁₀⁺,
R₈, R₉ and R₁₀ are each independently of each other H or linear or branched, saturated or unsaturated, C₁-C₁₀-alkyl, which is optionally substituted with OH and/or COOH, and
L is as defined above.
31. The core-shell particles of item 28, wherein the non-ionic functional group comprises a polyalkylene oxide, preferably polyethylene oxide and/or polypropylene oxide.
32. The core-shell particles of one of items 28-31, wherein the functional group is bound to the layer far from the core via a urethane group.
33. The core-shell particles of one of items 27-31, wherein 0-30%, preferably 0 to 20%, more preferably 0.1 to 20% of the NCO groups in the polyisocyanate are converted with a compound comprising at least one functional group.
34. Composition, comprising at least one core-shell particle according to items 1-33.
35. The composition of item 34, wherein the composition comprises water.
36. The composition of item 34 or 35, wherein the composition further contains at least one surface-active reagent, particularly surfactant, a binding agent, a defoamer, a protective colloid and/or a thickening agent.
37. The composition of item 36, wherein the binding agent is a polymer with a glass transition temperature in the range of −45 to +45° C., particularly a polymer on the basis of (meth)acrylic acid ester, styrene, isoprene, butadiene, vinyl acetate and/or isocyanate.
38. The composition of one of items 34-37, wherein the defoamer is a mineral oil, a silicic acid or a silicone-containing defoamer.
39. The composition of one of items 34-38, wherein the core-shell particles according to items 1-33 make up 10 to 55 wt.-%, preferably 15 to 45 wt.-%, particularly preferred 20 to 37.5 wt.-% based on the total mass of the composition.
40. Method for preparing a core-shell particle of one of items 1-33 or a composition of one of items 34-39, comprising the steps:
   (i) providing at least one lipophilic compound, optionally slurried in a carrier oil,
   (ii) mixing the at least one lipophilic compound and optionally the carrier oil with
      at least one monomer with at least one ethylenically unsaturated group,
      water,
      at least one polymerization initiator,
      at least one protective colloid,
      optionally at least one surface-active reagent,
      optionally at least one chain regulator,
   under formation of an emulsion, wherein the water forms the continuous phase.
   (iii) treating the emulsion obtained in (ii) at elevated temperature while stirring,
   (iv) adding at least one, optionally partially blocked, polyisocyanate and at least one compound comprising at least two groups with NCO-reactive hydrogen atom and optionally adding at least one compound comprising at least one functional group and an NCO-reactive hydrogen atom,
   (v) optionally treating the mixture obtained in (iv) at elevated temperature,
   (vi) optionally adding at least one binding agent, defoamer, surface-active reagent and/or a thickening agent and
   (vii) optionally at least partially removing the water.
41. The method of item 40, wherein the disperse phase has a diameter D₅₀ of 0.1 to 100 μm, preferably 0.5 to 80 μm and more preferably 1 to 75 μm.
42. The method of item 40 or 41, wherein the protective colloid is selected from water-soluble polymer, particularly polyvinyl alcohol, cellulose derivatives, particularly hydroxyalkyl cellulose or carboxyalkyl cellulose, gum arabic, polyacrylic acid, polyacrylamides, polyvinylpyrrolidone and/or maleic acid anhydride copolymers.
43. The method of one of items 40-42, wherein the surface-active reagent is selected from anionic, cationic or non-ionic surfactants.
44. The method of one of items 40-43, wherein the polymerization initiator is a radical initiator, particularly a peroxide, an azo compound, a persulfate, a hydroperoxide and/or a redox initiator, or mixtures thereof.
45. The method of one of items 40-44, wherein the chain regulator is a sulfurous compound, particularly lauryl mercaptan or ethylhexylthioglycolate.
46. The method of one of items 40-45, wherein the solubilizer is mono-, di- or triglyceride, mineral oil, silicone oil, castor oil and/or isopropyl myristate.
47. The method of one of items 40-46, wherein step (iii) takes place at temperatures of 25 to 100° C., preferably 50 to 100° C.
48. The method of one of items 40-47, wherein step (iv) takes place at temperatures of 25 to 100° C., preferably 50 to 100° C.
49. The method of one of items 40-48, wherein step (v) is preferably carried out for 0.25 to 4 hours, preferably at temperatures of 25 to 100° C., preferably 30 to 90° C.
50. Core-shell particles obtainable by a method according to items 40-49.
51. Use of the core-shell particles of one of items 1-33 or 50 or the composition of one of items 34-39 for the functionalization of materials, particularly fibers, textile fabrics, construction materials, plastics, plastic foams, paint and varnish.
52. Method for the finishing of materials, particularly of textiles, comprising the steps
   (a) providing the core-shell particles of one of items 1-33 or 50 or the composition of one of items 34-39,
   (b) applying the core-shell particles or the composition to a material; and
   (c) thermally treating the material.
53. Materials, particularly fibers or textile materials, comprising core-shell particles of one of items 1-33 or 50 or the composition of one of items 34-39.

1. Core-shell particles comprising
(a) a core comprising at least one lipophilic compound and
(b) a shell comprising at least one layer close to the core and one layer far from the core, wherein the layer close to the core is obtainable by polymerization of at least one monomer with at least one ethylenically unsaturated group and wherein the monomer with at least one ethylenically unsaturated group does not have a nucleophilic group with active hydrogen atom, particularly no NCO-reactive hydrogen.

2. The core-shell particles of claim 1, wherein the layer far from the core is disposed on the layer close to the core.

3. The core-shell particles of claim 1, wherein the lipophilic compound is selected from pigments, dyes, fragrances, cosmetics, flame retardants, latent heat storage materials, biocides, catalysts, adhesives, adhesive components, hydrophobing agents, polymer building blocks, isocyanates, oils, silicone oils, waxes or mixtures thereof.

4. The core-shell particles of claim 1, wherein the layer close to the core is obtainable by polymerization of at least one monomer with at least one ethylenically unsaturated group having the structure: 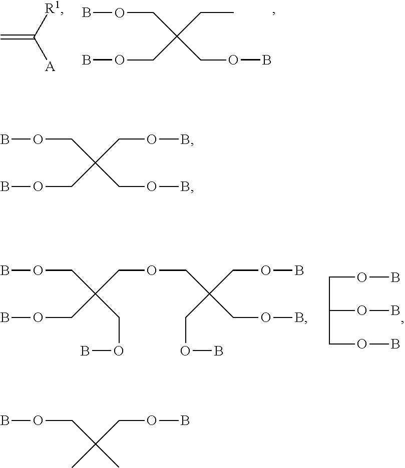
with 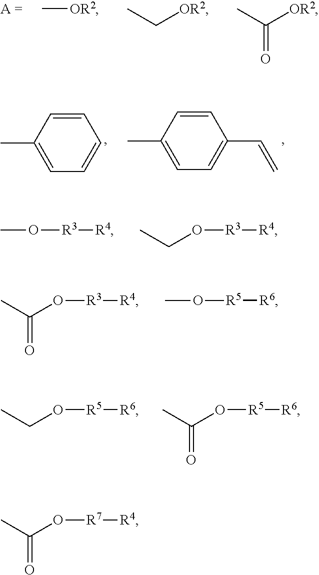
B=—R⁵-R⁶
R¹=—C₁-C₆-alkyl or —H, preferably —H or —CH₃,
R²=linear or branched C₁-C₂₄-alkyl,
R³=linear or branched C₁-C₂₄-alkylene, 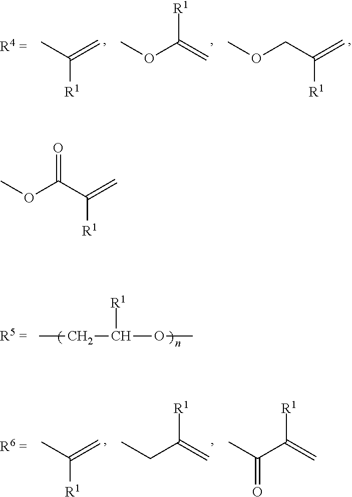
R⁷=polyester, particularly obtainable by reaction of C₁-C₆-alkyldiols and C₁-C₆-alkyldicarboxyilic acids, such as e.g. diester, e.g. malonic acid ester, oxalic acid ester, succinic acid ester, glutaric acid ester or adipic acid ester and
n=0-20

5. The core-shell particles of claim 1, wherein the layer far from the core contains at least one urethane, allophanate, carbodiimide, isocyanurate, biuret, uretdione, urea, iminooxadiazinedione or uretonimine group.

6. The core-shell particles of claim 1, wherein the layer far from the core is an addition product of at least one polyisocyanate and at least one compound comprising at least two groups with NCO-reactive hydrogen atom, preferably hydroxy, amino, carboxylic acid, urethane and/or urea groups.

7. The core-shell particles of claim 6, wherein the NCO groups of the polyisocyanate are partially blocked, particularly 0.1 to 80%, preferably 1 to 50%, more preferably 1 to 30% of the NCO groups of the polyisocyanate are blocked.

8. The core-shell particles of claim 1, wherein the layer far from the core has at least one functional group, preferably an anionic, cationic or non-ionic group, which is preferably bound to the layer far from the core via a urethane group.

9. Composition, comprising at least one core-shell particle according to claim 1.

10. The composition of claim 9, wherein the composition comprises water and optionally further at least one surface-active reagent, particularly surfactant, a binding agent, a defoamer, a protective colloid and/or a thickening agent.

11. Method for preparing a core-shell particle of claim 1, comprising:
(i) providing at least one lipophilic compound, optionally slurried in a carrier oil,
(ii) mixing the at least one lipophilic compound and optionally the carrier oil with
at least one monomer with at least one ethylenically unsaturated group,
water,
at least one polymerization initiator,
at least one protective colloid,
optionally at least one surface-active reagent,
optionally at least one chain regulator,
under formation of an emulsion, wherein the water forms the continuous phase.
(iii) treating the emulsion obtained in (ii) at elevated temperature while stirring,
(iv) adding at least one, optionally partially blocked, polyisocyanate and at least one compound comprising at least two groups with NCO-reactive hydrogen atom and optionally adding at least one compound comprising at least one functional group and an NCO-reactive hydrogen atom,
(v) optionally treating the mixture obtained in (iv) at elevated temperature,
(vi) optionally adding at least one binding agent, defoamer, surface-active reagent and/or a thickening agent and
(vii) optionally at least partially removing the water.

12. Core-shell particles obtainable by a method according to claim 11.

13. Use of the core-shell particle of claim 1 for the functionalization of materials, particularly fibers, textile fabrics, construction materials, plastics or plastic foams, paint and varnish.

14. Method for the finishing of materials, particularly of textiles, comprising:
(a) providing the core-shell particles of claim 1,
(b) applying the core-shell particles or the composition to a material; and
(c) thermally treating the material.

15. Materials, particularly fibers or textile materials, comprising core-shell particles of one claim 1.
